(19) United States
(12) Patent Application Publication
(10) Pub. No.: US 2018/0278417 A1
(43) Pub. Date: Sep. 27, 2018

(54) APPARATUS AND METHOD FOR GENERATING KEY, AND APPARATUS AND METHOD FOR ENCRYPTION

(71) Applicant: SAMSUNG SDS CO., LTD., Seoul (KR)

(72) Inventors: Kyu-Young CHOI, Seoul (KR); Hyo-Jin YOON, Seoul (KR); Duk-Jae MOON, Seoul (KR); Ji-Hoon CHO, Seoul (KR)

(73) Assignee: SAMSUNG SDS CO., LTD., Seoul (KR)

(21) Appl. No.: 15/933,548

(22) Filed: Mar. 23, 2018

(30) Foreign Application Priority Data
Mar. 23, 2017 (KR) 10-2017-0037074

(51) Int. Cl. H04L 9/08; H04L 9/30; H04L 9/32; H04L 9/14

(52) U.S. Cl. CPC H04L 9/0866; H04L 9/085; H04L 9/14; H04L 9/3247; H04L 9/30

(57) ABSTRACT

An apparatus for generating a key according to one exemplary embodiment of the present disclosure includes: a receiver configured to receive a key generation request including an identity (ID) from a key requesting apparatus; a converter configured to convert the ID into a first bit string; and a secret key generator configured to extract one or more secret parameter values corresponding to the first arbitrary bit string from a candidate secret parameter set, wherein the candidate secret parameter set includes a plurality of candidate secret parameter values and generate a secret key corresponding to the ID using the one or more extracted secret parameter values.

### CROSS-REFERENCE TO RELATED APPLICATION(S)

This application claims the benefit under 35 USC § 119(a) of Korean Patent Application No. 10-2017-0037074, filed on Mar. 23, 2017, in the Korean Intellectual Property Office, the entire disclosure of which is incorporated herein by reference for all purposes.

### BACKGROUND

### 1. Field

The following description relates to encryption and a key generation technology for encryption.

### 2. Description of Related Art

Recently, with the development of computer technology and the rapid expansion of communication networks, the security of computer-related resources and data to be sent has attracted attention as an important issue. A scheme for overcoming this problem is an encryption-based system. An encryption system that has made the greatest contribution up to the present is a public key encryption system. The conventional public key system has difficulty managing the certificates of public keys because the public keys of users should be authenticated in advance and certificates with problems should be discarded even before the expiration of their periods of validity. Accordingly, an identity (ID)-based encryption system based on personal IDs was proposed.

The public key-based encryption system uses a method of determining a private key and then computing a public key. In contrast, the ID-based encryption system uses a method of selecting an ID and then computing a private key based on the ID. In this case, a private key generator (PKG) computes the private key based on the ID and issues the private key via a secure channel.

In this regard, Korean Patent Registration No. 10-1301609, which is a related art, discloses a method of computing a secret key capable of ensuring a one-to-one correspondence relationship between an ID and the secret key by applying a discrete logarithm calculation method using a pre-computation table in an ID-based encryption system. However, due to the pre-computation, the method proposed in the related art requires a significant amount of time and costs (100 days by 100 cores on Amazon EC2) to generate secret keys for IDs of individual users. Therefore, there is a problem in that it is insufficient in terms of time and cost when separate key generation is required according to the provided service.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to an apparatus and method for generating a key for identity (ID)-based encryption, and an encryption apparatus and method.

In one general aspect, there is provided an apparatus for generating a key, comprising: at least one processor configured to implement: a receiver configured to receive a key generation request including an identity (ID) from a key requesting apparatus; a converter configured to convert the ID into a first bit string; and a secret key generator configured to extract one or more secret parameter values corresponding to the first bit string from a candidate secret parameter set, wherein the candidate secret parameter set includes a plurality of candidate secret parameter values, and generate a secret key corresponding to the ID using the one or more extracted secret parameter values.

The secret key generator may be further configured to divide the first bit string into a plurality of blocks and extract, from the candidate secret parameter set, the one or more secret parameter values based on the plurality of blocks.

The candidate secret parameter set may include the plurality of candidate secret parameter values respectively corresponding to one bit string among 2ⁿ different bit strings, each of length of n bits, and an order of a block including the one bit string, and wherein the secret key generator may divide the first bit string into the plurality of blocks in units of n bits and extract the one or more secret parameter values respectively corresponding to an order of each of the divided blocks and a bit string included in each of the divided blocks from the candidate secret parameter set.

The secret key generator may be further configured to generate the secret key corresponding to the ID from the extracted one or more secret parameter values using a one-way function.

In another general aspect, there is provided a method of generating a key including: receiving a key generation request including an identity (ID) from a key requesting apparatus; converting the ID into a first bit string; extracting one or more secret parameter values corresponding to the first bit string from a candidate secret parameter set, wherein the candidate secret parameter set includes a plurality of candidate secret parameter values; and generating a secret key corresponding to the ID using the one or more extracted secret parameter values.

The extracting of the one or more secret parameter values may include dividing the first bit string into a plurality of blocks and extracting, from the candidate secret parameter set the one or more secret parameter values based on the plurality of blocks.

The candidate secret parameter set may include the plurality of candidate secret parameter values respectively corresponding to one bit string among 2ⁿ different bit strings, each of length of n bits, and an order of a block including the one bit string, wherein dividing of the first bit string may divide the converted arbitrary bit string into the plurality of blocks in units of n bits, and wherein the extracting of the plurality of secret parameter values may extract the one or more secret parameter values respectively corresponding to an order of each of the divided blocks and a bit string included in each of the divided blocks from the candidate secret parameter set.

The generating the secret key may include generating the secret key corresponding to the ID from the one or more extracted secret parameter values using a one-way function.

In still another general aspect, there is provided an encryption apparatus including: at least one processor configured to implement: a key information acquirer configured to acquire a candidate public parameter set including a plurality of candidate public parameter values and a secret key corresponding to a user identity (ID) of the encryption apparatus from a key issuing server; an ID receiver configured to receive a user ID of an external device sharing the candidate public parameter set from the external device; a converter configured to convert the user ID of the external device into a first bit string; a public key generator configured to extract one or more public parameter values corresponding to the converted arbitrary bit string from the candidate public parameter set and generate a public key corresponding to the user ID of the external device using the extracted public parameter values; and an encryptor configured to encrypt data to be transmitted to the external device using the public key or generate a digital signature for the data to be transmitted using the secret key.

The public key generator may be further configured to divide the first bit string into a plurality of blocks and extract, from the candidate public parameter set, the one or more public parameter values based on the plurality of blocks.

The candidate public parameter set may include the plurality of candidate public parameter values respectively corresponding to one bit string among 2ⁿ different bit strings, each of length of n bits, and an order of a block including the one bit string, and wherein the public key generator may divide the first bit string into the plurality of blocks in units of n bits and extract the one or more public parameter values respectively corresponding to an order of each of the divided blocks and a bit string included in each of the divided blocks from the candidate public parameter set.

The public key generator may be further configured to generate the public key corresponding to the ID from the extracted one or more public parameter values using a one-way function.

The at least one processor is further configured to implement: an ID provider configured to provide the user ID of the encryption apparatus to the external device; a data receiver configured to receive data encrypted using a public key corresponding to the user ID of the encryption apparatus or data digitally signed using a secret key corresponding to the user ID of the external device from the external device; and a decryptor configured to decrypt the encrypted data using the secret key corresponding to the user ID of the encryption apparatus or perform verification of the digitally signed data using the public key corresponding to the user ID of the external device.

In yet another general aspect, there is provided an encryption method performed by an encryption apparatus, the encryption method including: acquiring a candidate public parameter set including a plurality of candidate public parameter values and a secret key corresponding to a first user identity (ID) of the encryption apparatus from a key issuing server; receiving a second user ID of an external device sharing the candidate public parameter set from the external device; converting the second user ID of the external device into a first bit string; extracting one or more public parameter values corresponding to the first bit string from the candidate public parameter set; generating a public key corresponding to the second user ID of the external device using the extracted one or more public parameter values; and encrypting data to be transmitted to the external device using the public key or generating a digital signature for the data to be transmitted using the secret key.

The generating of the public key may include dividing the first bit string into a plurality of blocks and extracting, from the candidate public parameter set, the one or more parameter values based on the plurality of blocks.

The candidate public parameter set may include the plurality of candidate public parameter values respectively corresponding to one bit string among 2ⁿ different bit strings, each of length of n bits, and an order of a block including the one bit string, wherein the dividing of the converted arbitrary bit string may divide the first bit string into the plurality of blocks in units of n bits, and wherein the extracting of the plurality of public parameter values may extract the one or more public parameter values respectively corresponding to an order of each of the divided blocks and a bit string included in each of the divided blocks from the candidate public parameter set.

The generating of the public key may include generating the public key corresponding to the second user ID from the extracted public parameter values using a one-way function.

The encryption method may further include: providing the first user ID of the encryption apparatus to the external device; receiving data encrypted using a public key corresponding to the first user ID of the encryption apparatus or data digitally signed using a secret key corresponding to the second user ID of the external device from the external device; and decrypting the encrypted data using the secret key corresponding to the first user ID of the encryption apparatus or performing verification of the digitally signed data using the public key corresponding to the second user ID of the external device.

Other features and aspects will be apparent from the following detailed description, the drawings, and the claims.

### BRIEF DESCRIPTION OF THE DRAWINGS

FIG. 1 is a diagram illustrating a configuration of an encryption system according to one exemplary embodiment of the present disclosure.

FIG. 2 is a diagram illustrating a configuration of an apparatus for generating a key according to one exemplary embodiment of the present disclosure.

FIG. 3 is a diagram illustrating one example of a candidate secret parameter set.

FIG. 4 is a diagram for describing an example of secret parameter value extraction.

FIG. 5 is a diagram illustrating a configuration of an apparatus for generating a key according to an additional exemplary embodiment of the present disclosure.

FIG. 6 is a diagram illustrating one example of a candidate public parameter set corresponding to the candidate secret parameter set shown in FIG. 3.

FIG. 7 is a diagram illustrating a configuration of an encryption apparatus according to one exemplary embodiment of the present disclosure.

FIG. 8 is a diagram for describing one example of public parameter value extraction.

FIG. 9 is a flowchart illustrating a secret key generation process according to one exemplary embodiment of the present disclosure.

FIG. 10 is a flowchart illustrating a candidate secret parameter set and a candidate public parameter set generation process according to one exemplary embodiment of the present disclosure.

FIG. 11 is a flowchart illustrating an encryption process according to one exemplary embodiment of the present disclosure.

FIG. 12 is a flowchart illustrating a decryption process according to one exemplary embodiment of the present disclosure.

FIG. 13 is a flowchart illustrating a digital signature generation process according to one exemplary embodiment of the present disclosure.

FIG. 14 is a flowchart illustrating a process of verifying digitally signed data according to one exemplary embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made on the basis of the overall context. The terminology used in the detailed description is provided only to describe embodiments of the present disclosure and not for purposes of limitation. Unless the context clearly indicates otherwise, the singular forms include the plural forms. It should be understood that the terms “comprises” or “includes” specify some features, numbers, steps, operations, elements, and/or combinations thereof when used herein, but do not preclude the presence or possibility of one or more other features, numbers, steps, operations, elements, and/or combinations thereof in addition to the description.

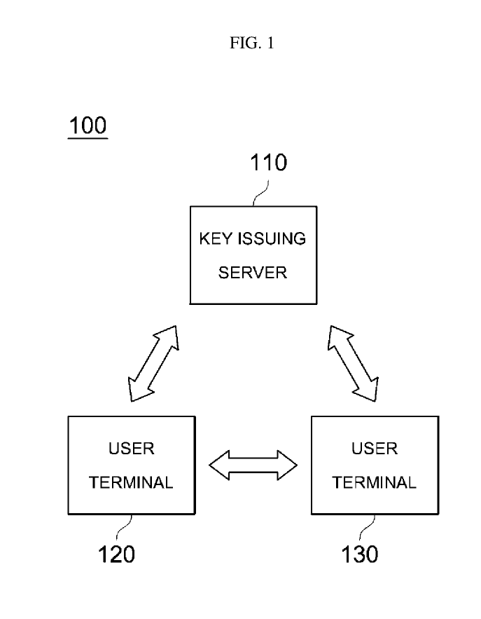

FIG. 1 is a diagram illustrating a configuration of an encryption system according to one exemplary embodiment of the present disclosure.

Referring to FIG. 1, an encryption system 100 according to one exemplary embodiment of the present disclosure includes a key issuing server 110 and user terminals 120 and 130.

The key issuing server 110 is a server operated by, for example, a trusted authority or an encryption service provider, and may generate key information for encryption according to a key generation request of the user terminals 120 and 130. Also, the key issuing server 110 may provide the generated key information to each of the user terminals 120 and 130 through a secure channel.

In this case, as described below, the key information may include at least one of a public key corresponding to a user ID of each of the user terminals 120 and 130 and a candidate public parameter set including plurality of candidate public parameter values for generating a public key corresponding to an arbitrary ID.

Each of the user terminals 120 and 130 may be a device for performing encryption/decryption or digital signature and verification of data by receiving key information provided from the key issuing server 110. For example, each of the user terminals 120 and 130 may be various types of computing devices, such as a smartphone, a personal digital assistant (PDA), a pablet, a desktop personal computer (PC), a tablet PC, a server, a sensor, and the like, which has an information processing function, a data storage function, and a data communication function through a wired or wireless network.

Each of the user terminals 120 and 130 may transmit a user ID to the key issuing server 110 to request key generation. In addition, each of the user terminals 120 and 130 may receive a candidate public parameter set and a secret key corresponding to a user ID from the key issuing server 110.

The secret key transmitted from the key issuing server 110 to each of the user terminals 120 and 130 may have a different value according to the user ID transmitted from each of the user terminals 120 and 130. On the other hand, the candidate public parameter set transmitted from the key issuing server 110 to each of the user terminals 120 and 130 may be the same, regardless of the user ID transmitted from each of the user terminals 120 and 130. Accordingly, the user terminals 120 and 130 may share the same candidate public parameter set.

Each of the user terminals 120 and 130 which has received the secret key and the candidate public parameter set from the key issuing server 100 may perform encryption/decryption using the received secret key and candidate public parameter set, or may perform digital signature on data and verification of the digitally signed data.

For example, the user terminal 120 may receive a user ID of the user terminal 130 and generate a public key corresponding to the received user ID using the candidate public parameter set. In addition, the user terminal 120 may encrypt data using the generated public key and then transmit the encrypted data to the user terminal 130.

In this case, the user terminal 130 may decrypt the encrypted data received from the user terminal 120 using the received secret key received from the key issuing server 110.

Similarly, the user terminal 130 may receive a user ID of the user terminal 120, and generate a public key corresponding to the received user ID using the candidate public parameter set. In addition, the user terminal 130 may encrypt data using the generated public key and transmit the encrypted data to the user terminal 120.

In this case, the user terminal 120 may decrypt the encrypted data received from the user terminal 130 using the secret key received from the key issuing server 110.

In another example, the user terminal 120 may generate a digital signature for data using the secret key received from the key issuing server 110 and provide the digitally signed data and the user ID of the user terminal 120 to the user terminal 130.

In this case, the user terminal 130 which has received the digitally signed data and the user ID of the user terminal 120 from the user terminal 120 may generate a public key corresponding to the received user ID using the candidate public parameter set. Thereafter, the user terminal 130 may perform verification of the received digitally signed data using the generated public key.

Also, similarly, the user terminal 130 may generate a digital signature for data using the secret key received from the key issuing server 110 and provide the digitally signed data and the user ID of the user terminal 130 to the user terminal 120.

The user terminal 120 which has received the digitally signed data and the user ID of the user terminal 130 from the user terminal 130 may generate a public key corresponding to the received user ID using the candidate public parameter set. Thereafter, the user terminal 120 may perform verification of the received digitally signed data using the generated public key.

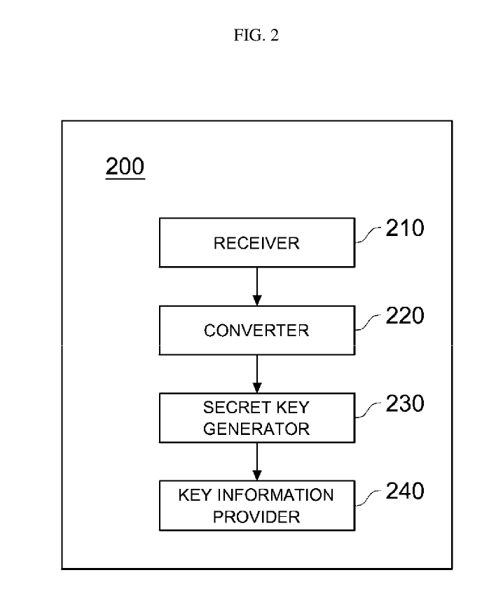

FIG. 2 is a diagram illustrating a configuration of an apparatus for generating a key according to one exemplary embodiment of the present disclosure.

Referring to FIG. 2, an apparatus 200 for generating a key according to one exemplary embodiment of the present disclosure includes a receiver 210, a converter 220, a secret key generator 230, and a key information provider 240.

In one exemplary embodiment of the present disclosure, the apparatus 200 for generating a key may be implemented, for example, as a configuration of the key issuing server 100 shown in FIG. 1.

The receiver 210 receives a key generation request including a user ID from a key requesting apparatus (for example, user terminals 120 and 130 of FIG. 1).

The converter 220 converts the user ID received from the key requesting apparatus into an arbitrary bit string. The adjective “arbitrary” indicates that the relationship of the resulting bit string to the user ID is not easily discoverable by inspection of the resulting bit string. In general, there is a deterministic mapping, relationship or function from the user ID to the arbitrary bit string. For example, generally, a unique resulting bit string is associated with a given user ID and mapping. Such a mapping may be represented, for example, by a hash function.

More specifically, according to one exemplary embodiment of the present disclosure, the converter 220 may convert the user ID received from the key requesting apparatus to an arbitrary bit string of a predetermined size using, for example, a hash function. However, the converter 220 may convert the user ID received from the key requesting apparatus into an arbitrary bit string using various known methods capable of generating an arbitrary bit string of a predetermined size from an arbitrary ID, in addition to the hash function.

The secret key generator 230 extracts one or more secret parameter values corresponding to the arbitrary bit string converted by the converter 220 from a candidate secret parameter set including a plurality of candidate secret parameter values. In addition, the secret key generator 230 generates a secret key corresponding to the received user ID using the extracted secret parameter values.

According to one exemplary embodiment of the present disclosure, the secret key generator 230 may divide the arbitrary bit string converted by the converter 220 into a plurality of blocks, and extract a plurality of secret parameter values corresponding to each of the blocks divided from the candidate secret parameter set.

More specifically, the secret key generator 230 may divide the arbitrary bit string converted by the converter 220 into m blocks in units of n bits, and extract a plurality of secret parameter values respectively corresponding to the order of each divided block and a bit string of n bits included in each divided block from the plurality of candidate secret parameter values included in the candidate secret parameter set.

At this time, the candidate secret parameter set may include 2ⁿ×m candidate secret parameter values respectively corresponding to one bit string among 2ⁿ different bit strings, each of length of n bits, and the order of a block including the corresponding bit string.

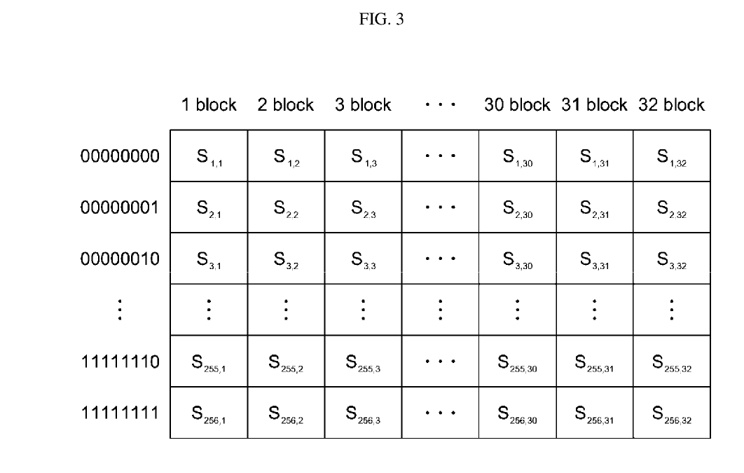

FIG. 3 is a diagram illustrating one example of a candidate secret parameter set.

In the example shown in FIG. 3, the candidate secret parameter set include 2⁸×32 candidate secret parameter values and each of the candidate secret parameter values corresponds to one block of 32 blocks and one bit string of different bit strings, each of length of 8 bits.

More specifically, S_{1,1} represents a candidate secret parameter value corresponding to a bit string of ‘00000000’ and the first block (i.e., 1 block), and S_{256,32} represents a candidate secret parameter value corresponding to a bit string of ‘11111111’ and the 32^{nd} block (i.e., 32 block).

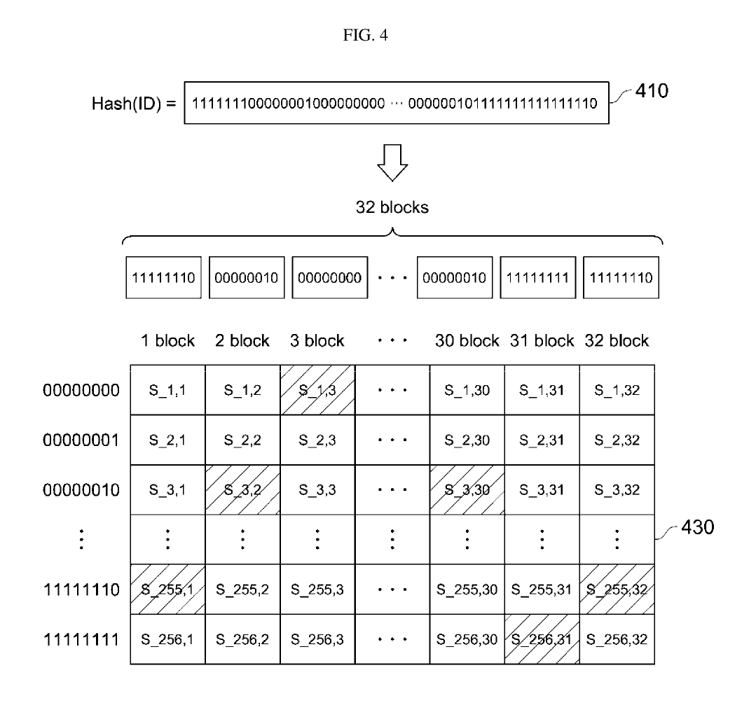

FIG. 4 is a diagram for describing an example of secret parameter value extraction.

Referring to FIG. 4, the converter 220 may convert an ID received from the key requesting apparatus into an arbitrary bit string 410 using, for example, a hash function, such as sha-256.

Then, the secret key generator 230 may divide the bit string 410 converted by the converter 220 into 32 blocks in units of 8 bits, and extract a parameter value corresponding to each of the divided blocks from candidate secret parameter values included in a candidate secret parameter set 430.

More specifically, in the example shown in FIG. 4, a bit string included in the first block among the 32 blocks divided from the bit string 410 is ‘1111110’, and thus the secret key generator 230 may extract S_{255,1}, which is a candidate secret parameter value corresponding to ‘1 block’ and the bit string of ‘1111110’, from the candidate secret parameter set 430.

In addition, a bit string included in the second block among the 32 blocks divided from the bit string 410 is ‘00000010’, and thus the secret key generator 230 may extract S_{3,2}, which is a candidate secret parameter value corresponding to ‘2 block’ and the bit string of ‘00000010’, from the candidate secret parameter set 430.

In the same manner, the secret key generator 230 may extract a secret parameter value corresponding to each of the 32 blocks divided from the bit string 410 from the candidate secret parameter set 430.

Accordingly, in the example shown in FIG. 4, the secret parameter values extracted by the secret key generator 230 are {S_{255,1}, S_{3,2}, S_{1,3}, . . . , S_{3,30}, S_{256,31}, S_{255,32}}.

According to one exemplary embodiment of the present disclosure, the secret key generator 230 may generate a secret key corresponding to the received user ID by multiplying or summing the secret parameter values extracted from the candidate secret parameter set.

For example, the secret key generator 230 may generate a secret key sk corresponding to the received user ID from the secret parameter values extracted in the example shown in FIG. 4 using the following Equation 1 or 2.

sk=S_{255,1}+S_{3,2}+_{1,3}+ . . . +S_{3,30}+S_{256,31}+S_{255,32} (1)

sk=S_{255,1}×S_{3,2}×S_{1,3}× . . . ×S_{3,30}×S_{256,31}×S_{255,32} (2)

However, in addition to the multiplication or summation of the extracted secret parameter values, the secret key generator 230 may generate a secret key using various types of one-way functions F1, which are easy to generate a secret key from the extracted secret parameter values but mathematically difficult to obtain the inverse.

Referring back to FIG. 2, the key information provider 240 transmits the secret key generated by the secret key generator 230 to the key requesting apparatus which has transmitted the user ID.

Meanwhile, in the above example, a size of an arbitrary bit string converted from the received ID, the number m of blocks divided from the converted arbitrary bit string, and the size n of a bit string included in each of the divided blocks may be preset to appropriate values in consideration of cryptographic security and computation amount. Hereinafter, m and n will be interpreted as the above description.

In one exemplary embodiment, the receiver 210, the converter 220, the secret key generator 230, and the key information provider 240 which are shown in FIG. 2 may be implemented on one or more computing devices, each including one or more processors and a computer-readable medium connected to the processor. The computer-readable recording medium may be present inside or outside processors and be connected to the processors by various well-known means. The processors present inside each of the computing devices may allow each computing device to operate according to exemplary embodiments described herein. For example, the processors may execute an instruction stored in the computer-readable recording medium, and the instruction stored in the computer-readable recording medium may be configured to allow the computing device to execute operations according to the exemplary embodiments described herein when executed by the processors.

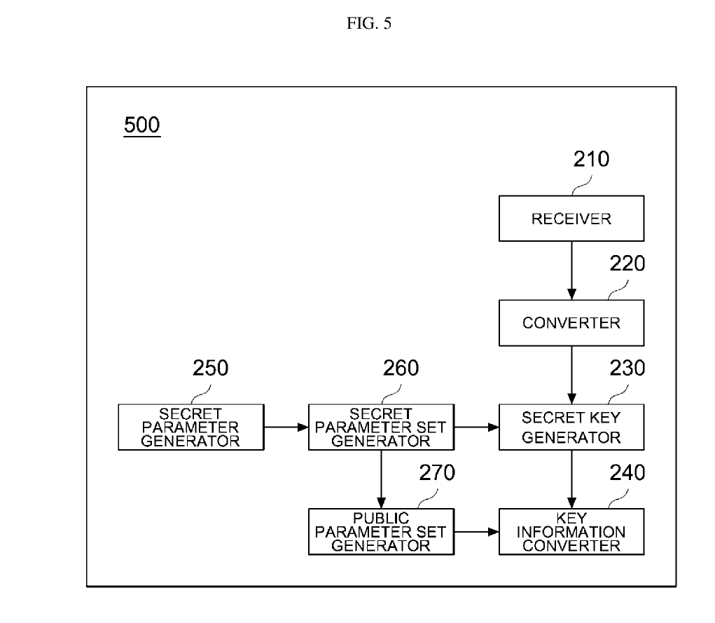

FIG. 5 is a diagram illustrating a configuration of an apparatus for generating a key according to an additional exemplary embodiment of the present disclosure.

Referring to FIG. 5, an apparatus 500 for generating a key according to an additional exemplary embodiment of the present disclosure may further include a secret parameter generator 250, a secret parameter set generator 260, and a public parameter set generator 270.

The secret parameter generator 250 generates a plurality of candidate secret parameter values.

In this case, the candidate secret parameter values generated by the secret parameter generator 250 may be arbitrarily generated values, and the manner in which the candidate secret parameter values are generated is not limited in any particular way as long as it is capable of generating a plurality of arbitrary values.

The number of candidate secret parameter values included in a candidate secret parameter set may be determined by a length of an arbitrary bit string converted by a converter 220 and the number of blocks divided from the arbitrary bit string by a secret key generator 230.

More specifically, when it is assumed that the length of the arbitrary bit string converted by the converter 220 is n×m bits and the corresponding arbitrary bit string is divided into m blocks in units of n bits, the number of candidate secret parameter values included in the candidate secret parameter set may be 2ⁿ×m.

The secret parameter set generator 260 generates a candidate secret parameter set including the candidate secret parameter values generated by the secret parameter generator 250.

More specifically, each of the 2ⁿ×m candidate secret parameter values included in the candidate secret parameter set may be indexed to one bit string among different 2ⁿ bit strings, each of length of n bits, and the order of a block including the corresponding bit string in m blocks.

For example, when a length of the arbitrary bit string converted by the converter 220 is 256 bits and the arbitrary bit string is divided into 32 blocks in units of 8 bits, the secret parameter set generator 260 may generate a candidate secret parameter set including 2⁸×32 candidate secret parameter values, each of which is indexed to one of 2⁸ different bit strings, each of length of 8 bits, and one of 32 blocks.

The public parameter set generator 270 generates a candidate public parameter set including a plurality of candidate public parameter values which correspond to the plurality of candidate secret parameter values included in the candidate secret parameter set generated by the secret parameter set generator 260, respectively, and are indexed in the same manner as the corresponding candidate secret parameter values.

More specifically, according to one exemplary embodiment of the present disclosure, the candidate public parameter set generator 210 may generate the candidate public parameter value using modular exponentiation or scalar multiplication which uses the candidate secret parameter values included in the candidate secret parameter set.

For example, the public parameter set generator 270 may generate the candidate public parameter value using the following Equation 3 or 4.

R=g^{s} mod p (3)

Here, R denotes a candidate public parameter value, S denotes a candidate secret parameter value, p denotes a prime number, and g denotes a generator of a multiplicative group having an order p.

R=S·P (4)

Here, P denotes a generator of a multiplicative group having an order p.

The public parameter set generator 270 may generate the candidate public parameter value using various types of one-way functions F2, which are easy to generate a candidate parameter value from a candidate secret parameter value but mathematically difficult to obtain the inverse. In this case, the one-way function F2 for generating the candidate public parameter value is the same as or different from the one-way function F1 for generating the above-described secret key.

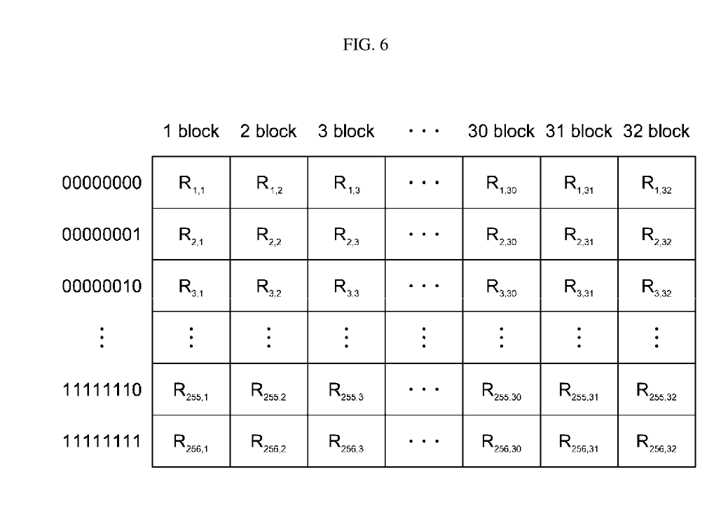

FIG. 6 is a diagram illustrating one example of a candidate public parameter set corresponding to the candidate secret parameter set shown in FIG. 3.

Referring to FIG. 3, the candidate public parameter set includes the same number of candidate public parameter values as the number of candidate secret parameter values included in the candidate secret parameter set. In addition, the candidate public parameter values included in the candidate public parameter set are indexed in the same manner as the corresponding candidate secret parameter values.

More specifically, R_{1,1} in the candidate public parameter set shown in FIG. 6 is a candidate public parameter value generated from a candidate secrete parameter value S_{1,1} included in the candidate secret parameter set shown in FIG. 3. Like S_{1,1}, R_{1,1} is indexed to a bit string of ‘00000000’ and the first block (i.e., ‘1 block’).

Referring back to FIG. 5, the key information provider 240 may provide the candidate public parameter set generated by the public parameter set generator 270 to a plurality of key requesting apparatuses. Accordingly, the plurality of key requesting apparatuses share the same candidate public parameter set.

In one exemplary embodiment, the receiver 210, the converter 220, the secret key generator 230, the key information provider 240, the secret parameter generator 250, the secret parameter set generator 260, and the public parameter set generator 270 shown in FIG. 5 may be implemented on computing devices, each including one or more processors and a computer-readable medium connected to the processor. The computer-readable recording medium may be present inside or outside processors and be connected to the processors by various well-known means. The processors present inside each of the computing devices may allow each computing device to operate according to exemplary embodiments described herein. For example, the processors may execute an instruction stored in the computer-readable recording medium, and the instruction stored in the computer-readable recording medium may be configured to allow the computing device to execute operations according to the exemplary embodiments described herein when executed by the processors.

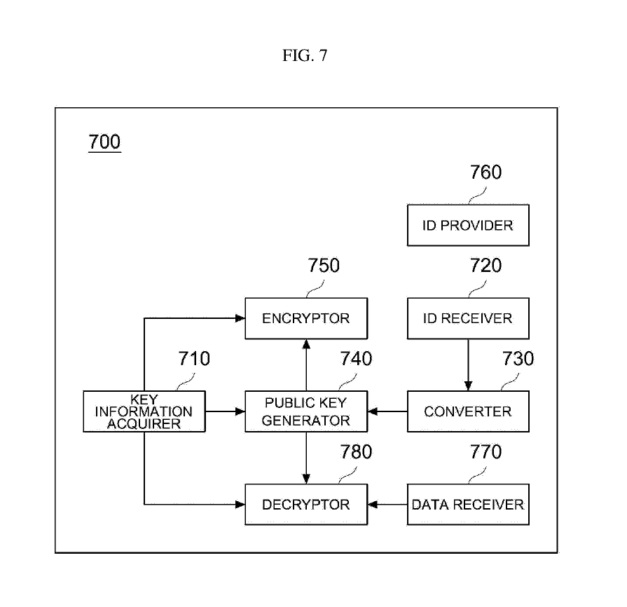

FIG. 7 is a diagram illustrating a configuration of an encryption apparatus according to one exemplary embodiment of the present disclosure.

Referring to FIG. 7, an encryption apparatus 700 according to one exemplary embodiment of the present disclosure includes a key information acquirer 710, an ID receiver 720, a converter 730, a public key generator 740, an encryptor 750, an ID provider 760, a data receiver 770, and a decryptor 780.

In one exemplary embodiment of the present disclosure, the encryption apparatus 700 may be implemented as a configuration of the user terminals 120 and 130 shown in FIG. 1.

The key information acquirer 719 transmits a key generation request including a user ID of the encryption apparatus 700 to a key issuing server 110. In addition, the key information acquirer 710 acquires a candidate public parameter set and a secret key corresponding to the user ID of the encryption apparatus 700 from the key issuing server 110.

In this case, the candidate public parameter set and the secret key acquired from the key issuing server 110 have already been described with respect to the apparatuses 200 and 500 for generating a key, and thus detailed descriptions thereof will be omitted.

The ID receiver 720 receives a user ID of an external device from the external device which shares the candidate public parameter set acquired from the key issuing server 110. In this case, the external device may be, for example, one of the user terminals 120 and 130 shown in FIG. 1.

The converter 730 converts the received user ID of the external device into an arbitrary bit string.

More specifically, the converter 730 may convert the received user ID of the external device into the arbitrary bit string in the same manner as the converter 220 shown in FIGS. 2 and 5.

The public key generator 740 extracts one or more public parameter values corresponding to the arbitrary bit string converted by the converter 730 from the candidate public parameter set. In addition, the public key generator 740 generates a public key corresponding to the user ID of the external device using the extracted public parameter values.

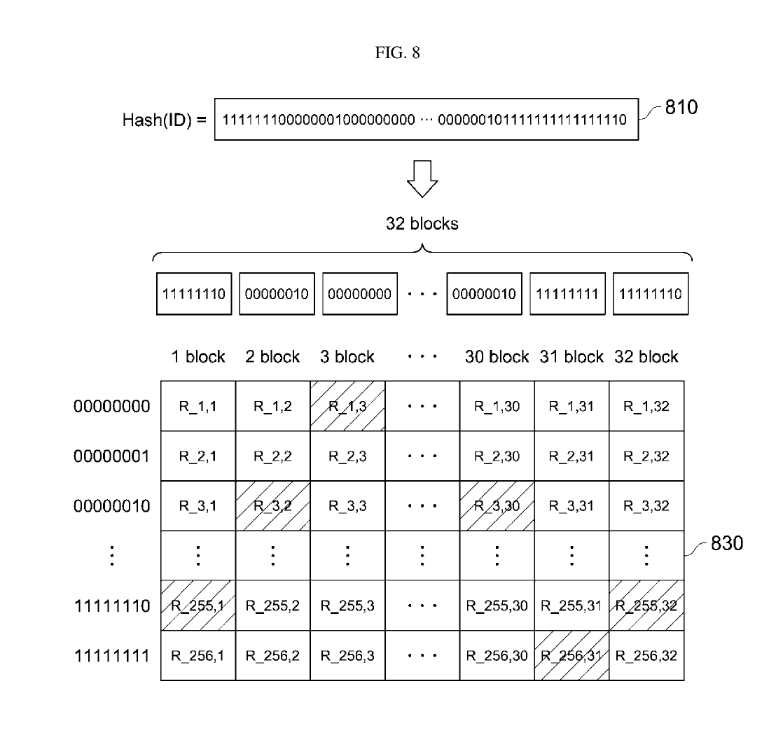

FIG. 8 is a diagram for describing one example of public parameter value extraction.

Referring to FIG. 8, the converter 730 may convert an ID received from the key requesting apparatus into an arbitrary bit string 810 using, for example, a hash function, such as sha-256.

Thereafter, the public key generator 740 may divide the bit string 810 converted by the converter 730 into 32 blocks in units of 8 bits, and extract a parameter value corresponding to each of the divided blocks from a candidate public parameter set 830.

More specifically, a bit string included in the first block among the divided blocks is ‘1111110’, and thus the public key generator 740 may extract R_{255,1} which is a candidate public parameter value corresponding to ‘1 block’ and the bit string of ‘1111110’ from the candidate public parameter set 830.

In addition, a bit string included in the second block among the divided blocks is ‘00000010’, and thus the public key generator 740 may extract R_{3,2} which is a candidate public parameter value corresponding to ‘2 block’ and the bit string of ‘00000010’ from the candidate public parameter set 830.

In the same manner, the public key generator 740 may extract a public parameter value corresponding to each of the blocks divided from the arbitrary bit string 810 from the candidate public parameter values included in the candidate public parameter set 830.

Accordingly, in the example shown in FIG. 8, the public parameter values extracted by the public key generator 740 are {R_{255,1}, R_{3,2}, S_{1,3}, . . . , R_{3,30}, R_{256,31}, R_{255,32}}.

According to one exemplary embodiment of the present disclosure, the public key generator 740 may generate the public key corresponding to the user ID of the external device by multiplying or summing the public parameter values extracted from the candidate public parameter set.

For example, the public key generator 740 may generate a public key pk from the public parameter values extracted in the example shown in FIG. 8 by using the following Equation 5 or 6.

pk=R_{255,1}+R_{3,2}+R_{1,3}+ . . . +R_{3,30}+R_{256,31}+R_{255,32} (5)

pk=R_{255,1}×R0_{3,2}×R_{1,3}× . . . ×R_{3,30}×R_{256,31}×R_{255,32} (6)

However, in addition to the multiplication or summation of the extracted public parameter values, the public key generator 740 may generate a public key using various types of one-way functions F3, which are easy to generate a public key from the extracted public parameter values but mathematically difficult to obtain the inverse. In this case, the one-way function F3 for generating the public key is the same as or different from the one-way function F1 for generating the above-described secret key or the one-way function F2 for generating the candidate public parameter value.

The encryptor 750 may encrypt data to be transmitted to the external device using the public key generated by the public key generator 740, or generate digital signature for the data to be transmitted to the external device using the secret key acquired by the key information acquirer 710.

For example, the encryptor 750 may select an arbitrary random number t and generate an encrypted message (C1, C2) for data M to be transmitted to the external device using the following Equations 7 and 8.

C1=g^{t}(mod p) (7)

C2=pk^{t}(mod p) XOR M (8)

The encryption or digital signature generation performed by the encryptor 750 is not necessarily limited to the above-described example, and various well-known schemes of public key encryption or digital signature schemes may be used.

The ID provider 760 provides the user ID of the encryption apparatus 700 to the external device.

The data receiver 770 receives the digitally signed data from the external device using the secret key of the external device or the data encrypted using the public key corresponding to the user ID of the encryption apparatus 700.

More specifically, the external device which has received the user ID of the encryption apparatus 700 may generate the public key corresponding to the user ID of the encryption apparatus 700 in the same manner as described above using the candidate public parameter set shared with the encryption apparatus 700, and may encrypt data using the generated public key and transmit the encrypted data to the encryption apparatus 700.

When the decryptor 780 receives the encrypted data from the external device, the decryptor 780 decrypts the encrypted data using the secret key acquired by the key information acquirer 710.

For example, when the encrypted data received from the external device is composed of encrypted messages C3 and C4 which have been generated in the same manner as in Equations 7 and 8, the decryptor 780 may decrypt the encrypted data as shown in the following Equation 9 using the secret key sk acquired by the key information acquirer 710.

M=C3^{sk}(mod p) XOR C4 (9)

Meanwhile, when the decryptor 780 receives the data digitally signed using the secret key of the external device from the external device, the decryptor 780 may perform verification of the digital signature using the public key for the user ID of the external device generated by the public key generator 740.

In one exemplary embodiment, the key information acquirer 710, the ID receiver 720, the converter 730, the public key generator 740, the encryptor 750, the ID provider 760, the data receiver 770, and the decryptor 780 may be implemented on one or more computing devices, each including one or more processors and a computer-readable medium connected to the processor. The computer-readable recording medium may be present inside or outside processors and be connected to the processors by various well-known means. The processors present inside each of the computing devices may allow each computing device to operate according to exemplary embodiments described herein. For example, the processors may execute an instruction stored in the computer-readable recording medium, and the instruction stored in the computer-readable recording medium may be configured to allow the computing device to execute operations according to the exemplary embodiments described herein when executed by the processors.

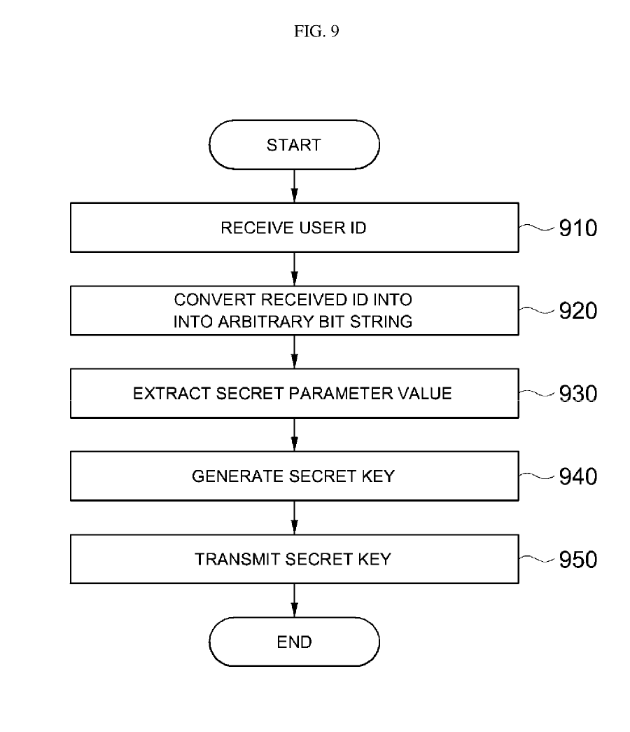

FIG. 9 is a flowchart illustrating a secret key generation process according to one exemplary embodiment of the present disclosure.

The method shown in FIG. 9 may be performed by, for example, the apparatus 200 for generating a key shown in FIG. 2.

Referring to FIG. 9, first, the apparatus 200 for generating a key receives a key generation request including a user ID of a key requesting apparatus from the key requesting apparatus (910).

Then, the apparatus 200 converts the received user ID into an arbitrary bit string (920).

The apparatus 200 extracts one or more secret parameter values corresponding to the converted arbitrary bit string from a plurality of candidate secret parameter values included in a candidate secret parameter set (930).

In this case, according to one exemplary embodiment of the present disclosure, the apparatus 200 may divide the converted arbitrary bit string into a plurality of blocks and extract a plurality of secret parameter values respectively corresponding to each of the divided blocks from among the plurality of candidate secret parameter values included in the candidate secret parameter set.

Then, the apparatus 200 generates a secret key corresponding to the received user ID using the extracted secret parameter values (940).

In this case, according to one exemplary embodiment of the present disclosure, the apparatus 200 may generate the secret key corresponding to the received ID from the extracted secret parameter values using a one-way function F1.

Thereafter, the apparatus 200 provides the generated secret key to the key requesting apparatus (950).

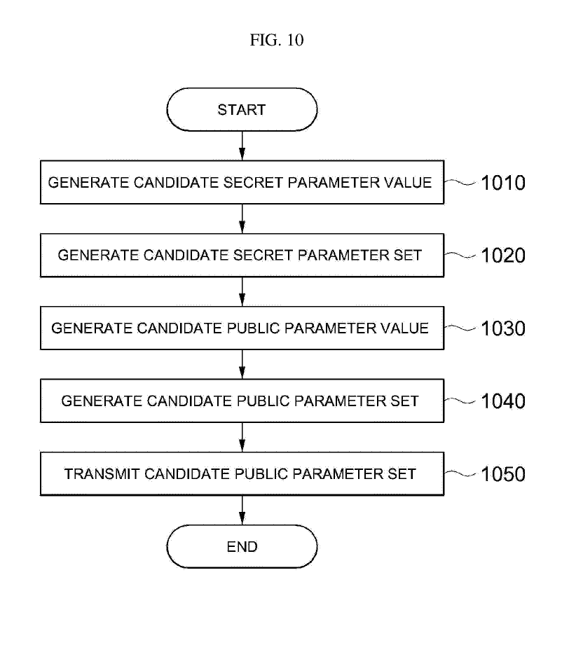

FIG. 10 is a flowchart illustrating a candidate secret parameter set and a candidate public parameter set generation process according to one exemplary embodiment of the present disclosure.

The method shown in FIG. 10 may be performed by the apparatus 500 for generating a key shown in FIG. 5.

Referring to FIG. 10, first, the apparatus 500 for generating a key generates a plurality of candidate secret parameter values (1010).

Then, the apparatus 500 generates a candidate secret parameter set including the generated candidate secret parameter values (1020).

In this case, according to one exemplary embodiment of the present disclosure, each of the candidate secret parameter values included in the candidate secret parameter set may be indexed to one bit string among different 2ⁿ bit strings, each of length of n bits, and the order of a block including the corresponding bit string in m blocks.

Then, the apparatus 500 generates a plurality of candidate public parameter values respectively corresponding to each of the plurality of candidate secret parameter values included in the candidate secret parameter set (1030).

In this case, according to one exemplary embodiment of the present disclosure, the apparatus 500 may generate the candidate public parameter values respectively corresponding to each of the candidate secret parameter values included in the candidate secret parameter set using a one-way function F2.

Then, apparatus 500 generates a candidate public parameter set including the plurality of generated candidate public parameter values (1040).

In this case, the candidate public parameter values included in the candidate public parameter set are indexed in the same manner as the corresponding candidate secret parameter values. That is, each of the candidate public parameter values included in the candidate public parameter set may be indexed to the same bit string and the same order of a block to which the corresponding candidate secret parameter value among the candidate secret parameter values included in the candidate secret parameter set is indexed.

Thereafter, the apparatus 500 transmits the generated candidate public parameter set to a plurality of key requesting apparatuses (1050).

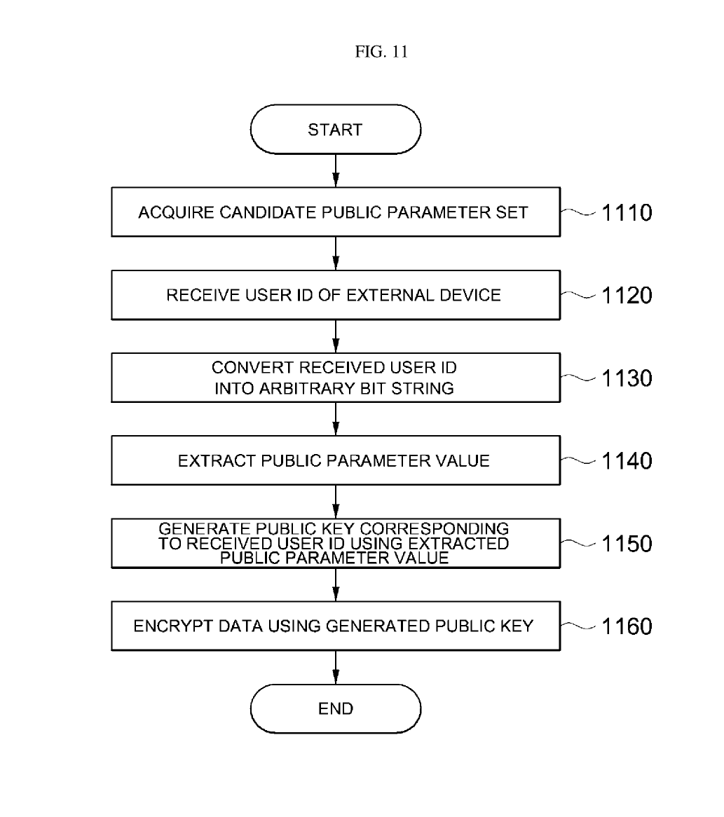

FIG. 11 is a flowchart illustrating an encryption process according to one exemplary embodiment of the present disclosure.

The method shown in FIG. 11 may be performed by, for example, the encryption apparatus 700 shown in FIG. 7.

Referring to FIG. 11, first, the encryption apparatus 700 acquires a candidate public parameter set including a plurality of candidate public parameter values from a key issuing server 100 (1110).

Then, the encryption apparatus 700 receives a user ID of an external device from the external device that shares the same candidate public parameter set as the acquired candidate public parameter set (1120).

Then, the encryption apparatus 700 converts the received user ID into an arbitrary bit string (1130).

Then, the encryption apparatus 700 extracts one or more public parameter values corresponding to the converted arbitrary bit string from among the plurality of candidate public parameter values included in the candidate public parameter set (1140).

In this case, according to one exemplary embodiment of the present disclosure, the encryption apparatus 700 may divide the converted arbitrary bit string into a plurality of blocks, and extract a plurality of public parameter values respectively corresponding to each of a plurality of divided blocks from among candidate public parameter values included in a candidate public parameter set.

Then, the encryption apparatus 700 generates a public key corresponding to the received user ID using the extracted public parameter values (1150).

In this case, according to one exemplary embodiment of the present disclosure, the encryption apparatus 700 may generate the public key corresponding to the received ID from the plurality of extracted public parameter values using a one-way function F3.

Thereafter, the encryption apparatus 700 encrypts data to be transmitted to the external device using the generated public key (1160).

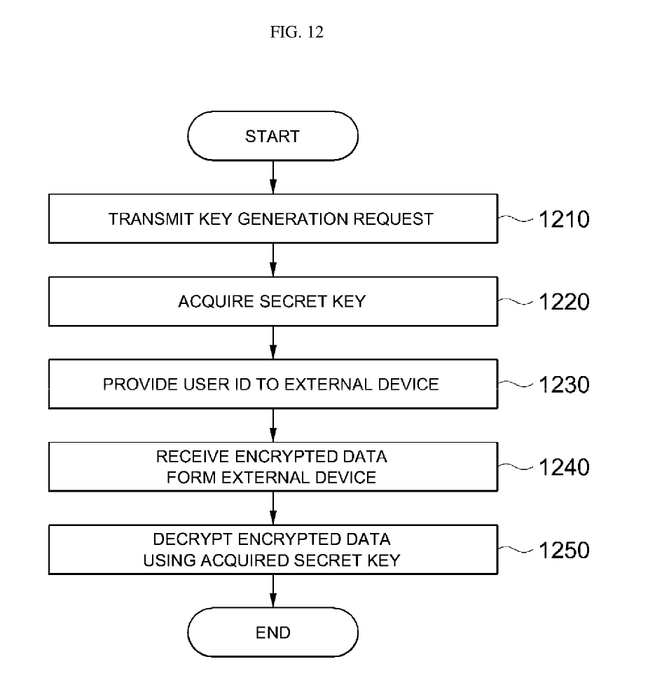

FIG. 12 is a flowchart illustrating a decryption process according to one exemplary embodiment of the present disclosure.

The method shown in FIG. 12 may be performed by, for example, the encryption apparatus 700 shown in FIG. 7.

Referring to FIG. 12, first, the encryption apparatus 700 transmits a key generation request including a user ID of an encryption apparatus 700 to a key issuing server 110 (1210).

Then, the encryption apparatus 700 acquires a secret key corresponding to the user ID of the encryption apparatus 800 from the key issuing server 110 (1220).

Then, the encryption apparatus 700 provides a user ID of the encryption apparatus 700 to an external device sharing a candidate public parameter set (1230).

Thereafter, the encryption apparatus 700 receives data encrypted using a public key corresponding to the user ID of the encryption apparatus 700 from the external device (1240).

Then, the encryption apparatus 700 decrypts the received encrypted data using the acquired secret key (1250).

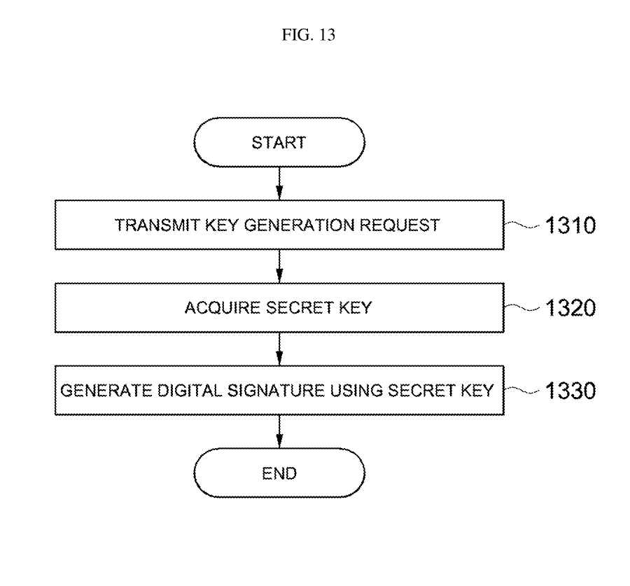

FIG. 13 is a flowchart illustrating a digital signature generation process according to one exemplary embodiment of the present disclosure.

The method shown in FIG. 13 may be performed by, for example, the encryption apparatus 700 shown in FIG. 7.

Referring to FIG. 13, first, the encryption apparatus 700 transmits a key generation request including a user ID of the encryption apparatus 700 to a key issuing server 110 (1310).

Thereafter, the encryption apparatus 700 acquires a secret key corresponding to the user ID of the encryption apparatus 700 from the key issuing server 110 (1320).

Then, the encryption apparatus 700 generates a digital signature for data to be transmitted to an external device sharing a candidate public parameter set using the acquired secret key (1330).

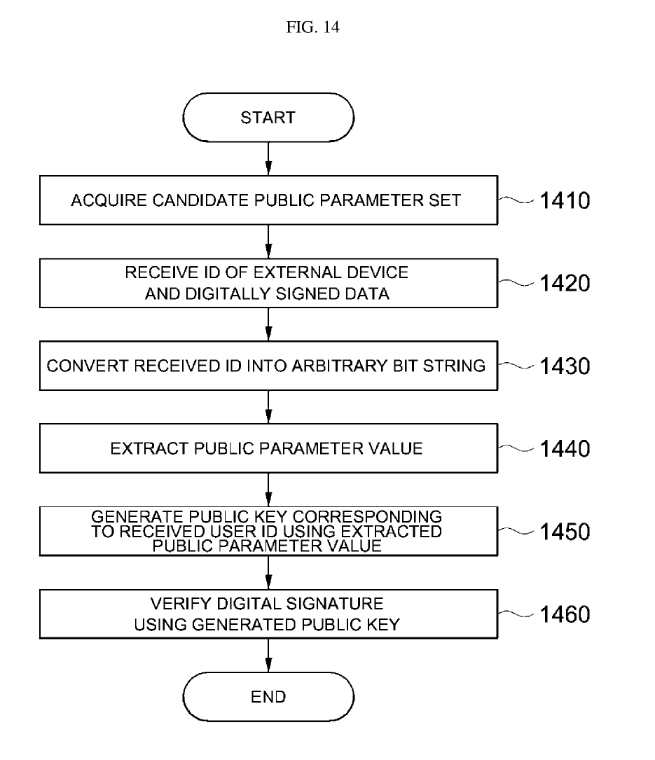

FIG. 14 is a flowchart illustrating a process of verifying digitally signed data according to one exemplary embodiment of the present disclosure.

The method shown in FIG. 14 may be performed by, for example, the encryption apparatus 700 shown in FIG. 7.

Referring to FIG. 14, first, the encryption apparatus 700 acquires a candidate public parameter set including a plurality of candidate public parameter values from a key issuing server (1410).

Then, the encryption apparatus 700 receives a user ID of an external device sharing the candidate public parameter set and data digitally signed using a secret key corresponding to the user ID of the external device from the external terminal (1420).

Then, the encryption apparatus 700 converts the received user ID into an arbitrary bit string (1430).

The encryption apparatus 700 extracts one or more public parameter values corresponding to the converted arbitrary bit string from the plurality of candidate public parameter values included in the candidate public parameter set (1440).

In this case, according to one exemplary embodiment of the present disclosure, the encryption apparatus 700 may divide the converted arbitrary bit string into a plurality of blocks and extract a plurality of public parameter values respectively corresponding to each of the divided blocks from among a plurality of candidate public parameter values included in a candidate public parameter set.

Then, the encryption apparatus 700 generates a public key corresponding to the user ID of the external device using the extracted public parameter values (1450).

In this case, according to one exemplary embodiment of the present disclosure, the encryption apparatus 700 may generate the public key corresponding to the received ID from the plurality of extracted public parameter values using a one-way function F3.

Thereafter, the encryption apparatus 700 performs verification of the digital signature using the generated public key (1460).

Meanwhile, in the flowcharts illustrated in FIGS. 9 to 14, the method is described as being divided into a plurality of operations. However, it should be noted that at least some of the operations may be performed in different order or may be combined into fewer operations or further divided into more operations. In addition, some of the operations may be omitted, or one or more extra operations, which are not illustrated, may be added to the flowchart and be performed.

According to the exemplary embodiments of the present disclosure, pre-computations required in prior arts is not required for generation of a cipher key corresponding to an ID and there is no restriction on IDs available for generating the cipher key. Thus, an amount of computation and processing time required for generating an cipher key can be remarkably reduced.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for generating a key, comprising:
at least one processor configured to implement:
a receiver configured to receive a key generation request including an identity (ID) from a key requesting apparatus;
a converter configured to convert the ID into a first bit string; and
a secret key generator configured to extract one or more secret parameter values corresponding to the first bit string from a candidate secret parameter set, wherein the candidate secret parameter set includes a plurality of candidate secret parameter values, and generate a secret key corresponding to the ID using the one or more extracted secret parameter values.

2. The apparatus of claim 1, wherein the secret key generator is further configured to divide the first bit string into a plurality of blocks and extract, from the candidate secret parameter set, the one or more secret parameter values based on the plurality of blocks.

3. The apparatus of claim 2, wherein the candidate secret parameter set includes the plurality of candidate secret parameter values respectively corresponding to one bit string among 2n different bit strings, each of length of n bits, and an order of a block including the one bit string, and
wherein the secret key generator divides the first bit string into the plurality of blocks in units of n bits and extracts the one or more secret parameter values respectively corresponding to an order of each of the divided blocks and a bit string included in each of the divided blocks from the candidate secret parameter set.

4. The apparatus of claim 1, wherein the secret key generator is further configured to generate the secret key corresponding to the ID from the extracted one or more secret parameter values using a one-way function.

5. A method of generating a key comprising:
receiving a key generation request including an identity (ID) from a key requesting apparatus;
converting the ID into a first bit string;
extracting one or more secret parameter values corresponding to the first bit string from a candidate secret parameter set, wherein the candidate secret parameter set includes a plurality of candidate secret parameter values; and
generating a secret key corresponding to the ID using the one or more extracted secret parameter values.

6. The method of claim 5, wherein the extracting of the one or more secret parameter values includes:
dividing the first bit string into a plurality of blocks; and
extracting, from the candidate secret parameter set, the one or more secret parameter values based on the plurality of blocks.

7. The method of claim 6, wherein the candidate secret parameter set includes the plurality of candidate secret parameter values respectively corresponding to one bit string among 2n different bit strings, each of length of n bits, and an order of a block including the one bit string, and
wherein the dividing of the first bit string divides the first bit string into the plurality of blocks in units of n bits and extracts the one or more secret parameter values respectively corresponding to an order of each of the divided blocks and a bit string included in each of the divided blocks from the candidate secret parameter set.

8. The method of claim 5, wherein the generating the secret key includes generating the secret key corresponding to the ID from the one or more extracted secret parameter values using a one-way function.

9. An encryption apparatus comprising:
at least one processor configured to implement:
a key information acquirer configured to acquire a candidate public parameter set including a plurality of candidate public parameter values and a secret key corresponding to a user identity (ID) of the encryption apparatus from a key issuing server;
an ID receiver configured to receive a user ID of an external device sharing the candidate public parameter set from the external device;
a converter configured to convert the user ID of the external device into a first bit string;
a public key generator configured to extract one or more public parameter values corresponding to the first bit string from the candidate public parameter set and generate a public key corresponding to the user ID of the external device using the extracted public parameter values; and
an encryptor configured to encrypt data to be transmitted to the external device using the public key or generate a digital signature for the data to be transmitted using the secret key.

10. The encryption apparatus of claim 9, wherein the public key generator is further configured to divide the first bit string into a plurality of blocks and extract, from the candidate public parameter set, the one or more public parameter values based on the plurality of blocks.

11. The encryption apparatus of claim 10, wherein the candidate public parameter set includes the plurality of candidate public parameter values respectively corresponding to one bit string among 2n different bit strings, each of length of n bits, and an order of a block including the one bit string, and
wherein the public key generator divides the first bit string into the plurality of blocks in units of n bits and extracts the one or more public parameter values respectively corresponding to an order of each of the divided blocks and a bit string included in each of the divided blocks from the candidate public parameter set.

12. The encryption apparatus of claim 9, wherein the public key generator is further configured to generate the public key corresponding to the ID from the extracted one or more public parameter values using a one-way function.

13. The encryption apparatus of claim 9, wherein the at least one processor is further configured to implement:
an ID provider configured to provide the user ID of the encryption apparatus to the external device;
a data receiver configured to receive data encrypted using a public key corresponding to the user ID of the encryption apparatus or data digitally signed using a secret key corresponding to the user ID of the external device from the external device; and
a decryptor configured to decrypt the encrypted data using the secret key corresponding to the user ID of the encryption apparatus or perform verification of the digitally signed data using the public key corresponding to the user ID of the external device.

14. An encryption method performed by an encryption apparatus, the encryption method comprising:
acquiring a candidate public parameter set including a plurality of candidate public parameter values and a secret key corresponding to a first user identity (ID) of the encryption apparatus from a key issuing server;
receiving a second user ID of an external device sharing the candidate public parameter set from the external device;
converting the second user ID of the external device into a first bit string;
extracting one or more public parameter values corresponding to the first bit string from the candidate public parameter set;
generating a public key corresponding to the second user ID of the external device using the extracted one or more public parameter values; and
encrypting data to be transmitted to the external device using the public key or generating a digital signature for the data to be transmitted using the secret key.

15. The encryption method of claim 14, wherein the generating of the public key includes:
dividing the first bit string into a plurality of blocks; and
extracting, from the candidate public parameter set, the one or more public parameter values based on the plurality of blocks.

16. The encryption method of claim 15, wherein the candidate public parameter set includes the plurality of candidate public parameter values respectively corresponding to one bit string among 2n different bit strings, each of length of n bits, and an order of a block including the one bit string, and
wherein the dividing of the first bit string divides the first bit string into the plurality of blocks in units of n bits and extracts the one or more public parameter values respectively corresponding to an order of each of the divided blocks and a bit string included in each of the divided blocks from the candidate public parameter set.

17. The encryption method of claim 14, wherein the generating of the public key includes generating the public key corresponding to the second user ID from the extracted one or more public parameter values using a one-way function.

18. The encryption method of claim 14, further comprising:
providing the first user ID of the encryption apparatus to the external device;
receiving data encrypted using a public key corresponding to the first user ID of the encryption apparatus or data digitally signed using a secret key corresponding to the second user ID of the external device from the external device; and
decrypting the encrypted data using the secret key corresponding to the first user ID of the encryption apparatus or performing verification of the digitally signed data using the public key corresponding to the second user ID of the external device.
